(19) United States
(12) Patent Application Publication
(10) Pub. No.: US 2008/0141737 A1
(43) Pub. Date: Jun. 19, 2008

(54) Locking device for a storage cabinet

(76) Inventor: Hsueh-Liang Chang, Taichung (TW)

Correspondence Address: POSZ LAW GROUP, PLC, 12040 SOUTH LAKES DRIVE, SUITE 101, RESTON, VA, 20191, US

(21) Appl. No.: 11/640,894

(22) Filed: Dec. 19, 2006

(51) Int. Cl. G07F 5/00

(52) U.S. Cl. 70/78

(57) ABSTRACT

A lock for a locker has a housing, a front panel, a control locking device and a main locking device. The housing has a coin passage device which has at least one adjustable coin plate. The position of the coin plate could be adjusted in the coin plate. Therefore, various coins could be put in the lock without changing the coin plate, and the use of the lock is convenient.

### BACKGROUND OF THE INVENTION

1. Field of the Invention

The present invention relates to a locking device, more particularly to a locking device for a storage cabinet, which is suitable for inserting any kinds of coins without changing a coin plate.

2. Description of the Related Art

Lockers are provided in many public places for use by the general public, and most of these lockers require payment for use. A conventional pay locker has a body, a door and a lock. The door is pivotally attached to the body. The conventional lock tends to be very complex, is mounted on the door and selectively engages the body, or vice versa, to lock the door and has a coin-activated enabling device, a locking mechanism and a key. A coin is inserted into the coin-activated enabling device to release the coin-activated enabling device. The key is mounted detachably in and locks or unlocks the locking mechanism when the key is rotated in the locking mechanism. When the key is rotated to lock the door after a coin has been inserted into the coin-activated enabling device, the key can be removed from the locking mechanism. However, a coin plate of a lock could not be suitable for various coins.

To overcome the shortcomings, the present invention provides a lock for a locker that is simple and convenient to use to obviate or mitigate the aforementioned problems.

### SUMMARY OF THE INVENTION

The primary objective of the present invention is to provide a lock for a locker that is simple and convenient to use.

A lock for a locker has a housing, a front panel, a control locking device and a main locking device. The housing has a coin passage device which has at least one adjustable coin plate. The position of the coin plate could be adjusted in the coin plate. Therefore, various coins could be put in the lock without changing the coin plate, and the use of the lock is convenient.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a lock for a locker in accordance with the present invention;

FIG. 2 is a partial exploded perspective view of the lock for a locker in FIG. 1;

FIG. 3 is a side view in partial section of the lock for a locker in FIG. 1;

FIG. 4 is a side view in partial section of the lock for a locker in FIG. 1; and

FIG. 5 is an exploded perspective view of a second embodiment of a lock for a locker in accordance with the present invention.

### DETAILED DESCRIPTION OF THE INVENTION

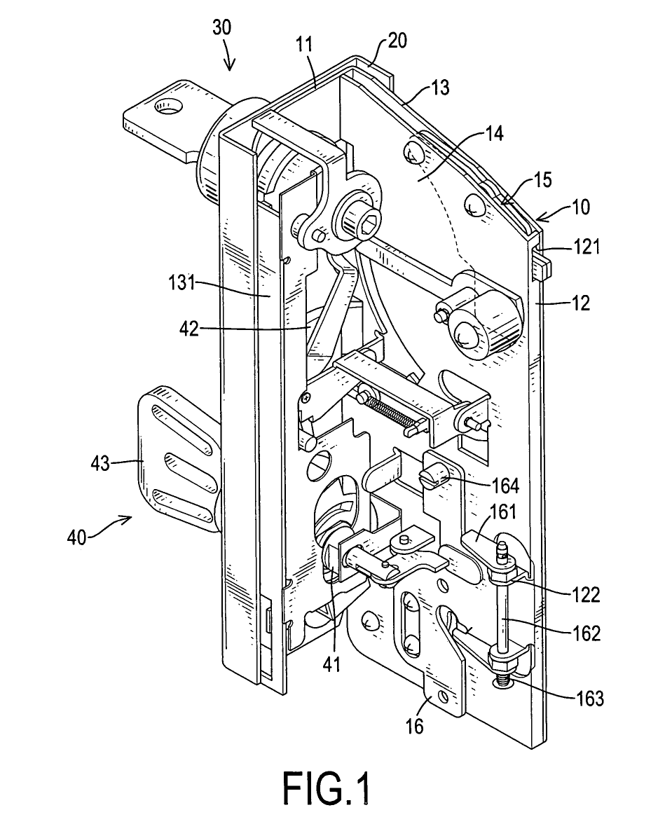

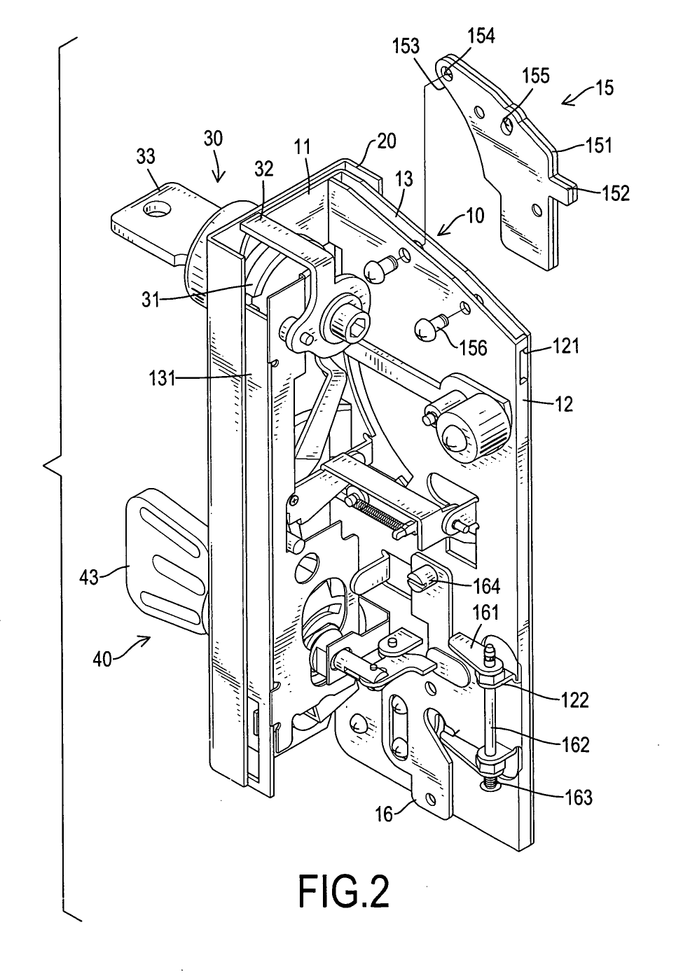

With reference to FIGS. 1 to 2, a first embodiment of a lock for a locker in accordance with the present invention has a housing (10), a front panel (20), a control locking device (30) and a main locking device (40).

The housing (10) has a bracket (11), a partition (12), a coin passage device (15) and a control slab (16).

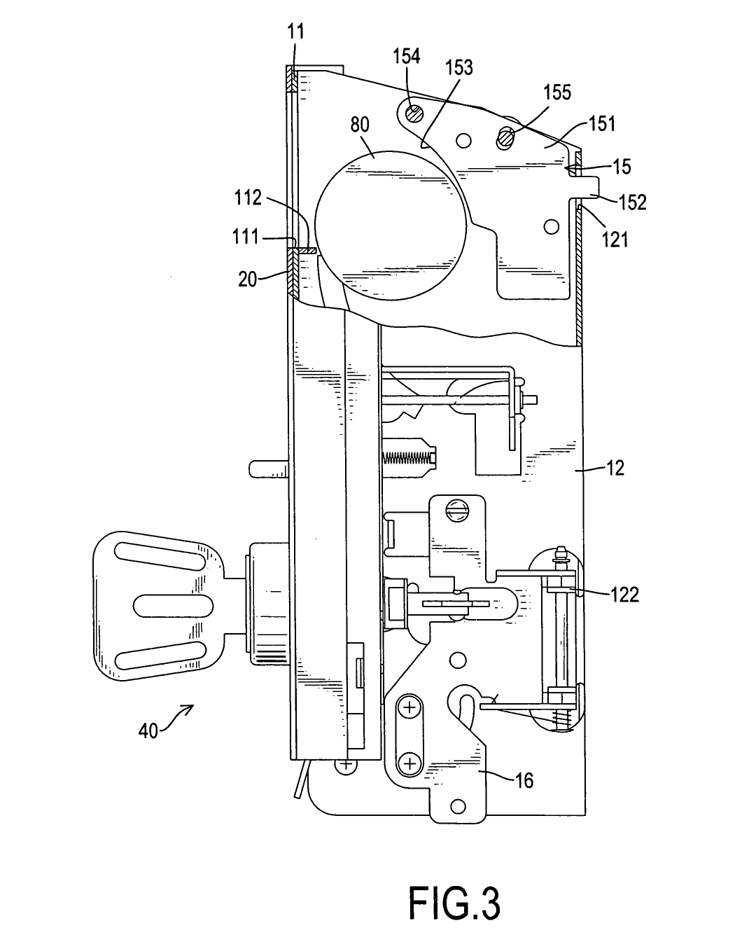

With further reference to FIG. 3, the bracket (11) has a front, a first sidewall (13) and a second sidewall (131). The front has two side edges, an inner surface, a coin slot (111) and a lip (112). The coin slot (111) is defined in the front for a coin putting into and has a bottom edge. The lip (112) is formed on the inner surface of the front at the bottom edge of the coin slot (111). The sidewalls (13, 131) are integrally formed with the side edges of the front. The two sidewalls (13, 131) are parallel to each other. The partition (12) is mounted between sidewalls (13, 131) and near the first sidewall (13).

The partition (12) has a surface, a rear edge, a slot (121) and a pivotal seat (122). The slot (121) is defined in the rear edge of the partition (12). The pivotal seat (122) is formed on the surface. A coin passage is formed between the partition (12) and the first sidewall (13).

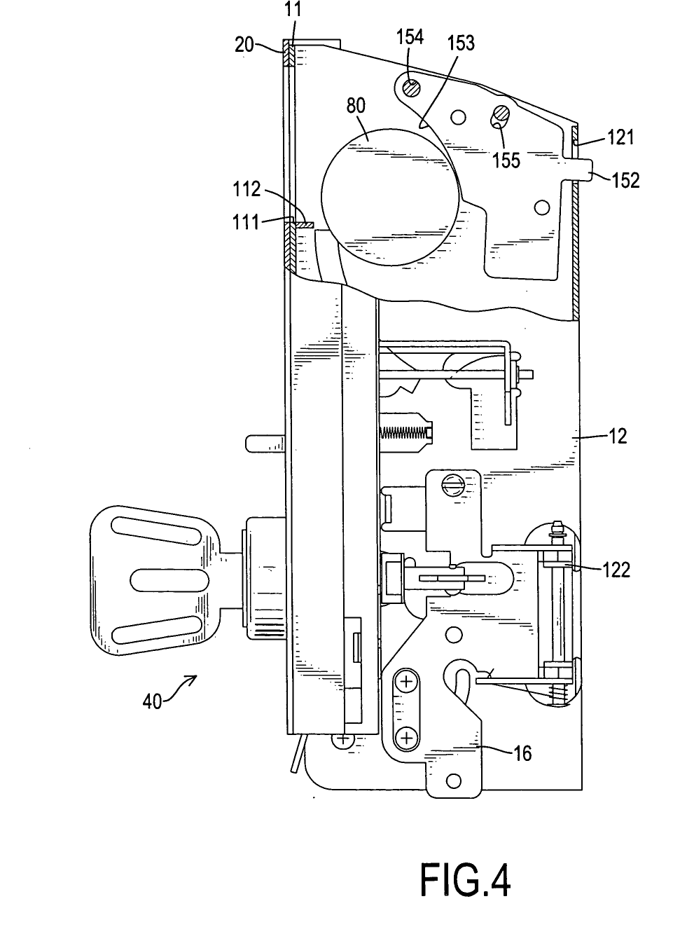

With further reference to FIGS. 3 and 4, the coin passage device (15) is mounted between the first sidewall (13) and the partition (12). The coin passage device (15) has at least one plate (151), a first fastener and a second fastener. In a preferred embodiment, the coin passage device (15) has two plates (151), and the two plates (151) are mounted between the first sidewall (13) and the partition (12) and are mounted side by side. Each plate (151) has a top, a front, a rear edge, an ear (152), an arc bottom edge (153), a mounting hole (154) and an elongated hole (155). The ear (152) is formed on the rear edge of the coin plate (15) and extends out of the slot (121) in the partition (12). The arc bottom edge (153) of the coin plate (15) forms a coin channel (14) for receiving coins and the coin channel (14) communicates with the coin slot (111) in the bracket (11) and the coin passage between the partition (12) and the first sidewall (13). The coin channel (14) has a distance between the arc bottom edge (153) and the lip (112) for allowing coins passing or not. The mounting hole (154) is defined through the plate (151) for the first fastener mounted inside. The elongated hole (155) is defined through the plate near the top for the second fastener mounted inside. If a coin (80) is input from the coin slot (111) in the front, the coin (80) is allowed for passing depending on the distance between the lip (112) and the arc bottom edge (153). Therefore, a user could adjust the position of the coin plate (15) by pushing the ear (152) upward or downward after unfastening the second fastener.

The control slab (16) is pivotally mounted on the pivotal seat (121) on the partition (12) and has two pivotal ears (161), a pivotal rod (162), a torsion spring (163) and a post (164). The pivotal rod (162) is mounted though the torsion spring (163) and the two pivotal ears (161) and then is combined with the pivotal seat (121). The post (164) is mounted on the control slab (16) and could be extended into the coin passage formed between the partition (12) and the first sidewall (13) for stopping a coin passing through the coin passage before the locker is locked. The way for setting the bracket (11) and the partition (12) is almost the same as a conventional lock for a locker, and no more described here.

The front panel (20) is mounted on the front of the bracket (11) and has a coin slot and two mounting holes. The coin slot is defined in the front panel (20) and faces the coin slot (111) in the bracket (11). The two mounting holes are defined in the front panel (20) for mounting the control locking device (30) and the main locking device (40).

The control locking device (30) is mounted on the housing (10) and the front panel (20) and has a locking cylinder (31), a lock holder (32) and a control key (33). The lock holder (32) is mounted with the locking cylinder (31). The control key (33) is used for operating the locking cylinder (31). The way for setting the control locking device (30) is almost the same as a conventional lock for a locker, so no more described here.

The main locking device (40) is mounted on the housing (10) and the front panel (20) and has a locking cylinder (41), a tongue (42) and a key (43). The locking cylinder (41) is mounted through the bracket (11) and the front panel (20) and could be used for pressing the control slab (16). The tongue (42) is retractably mounted with the locking cylinder (41). The key (43) is inserted into the locking cylinder (41) for operating the main locking device (40) and may be taken out from the locking cylinder (41) when the locker is locked.

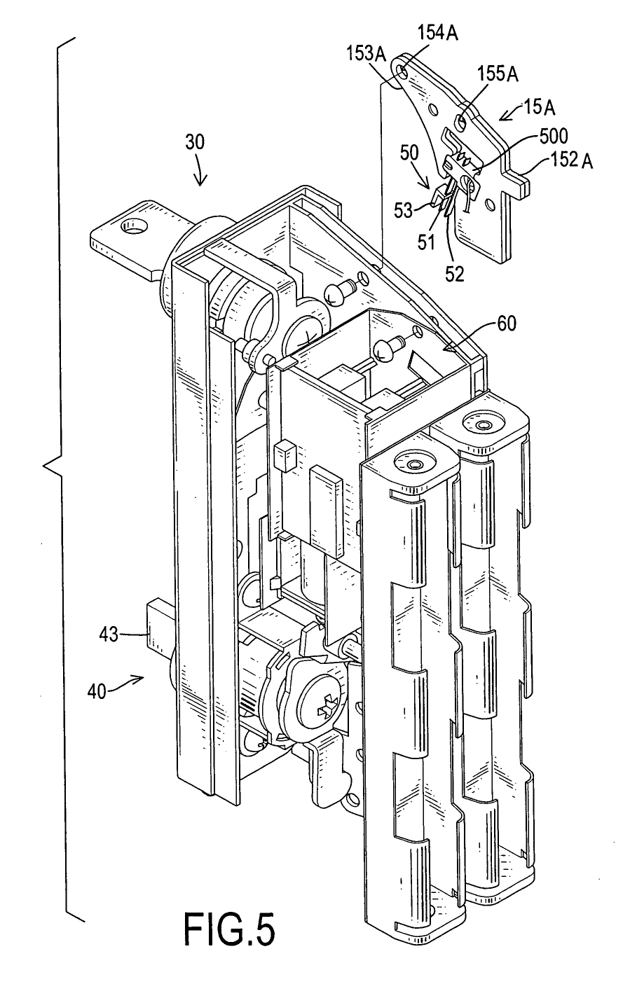

With reference to FIG. 5, a second embodiment of a lock for a locker is shown and has a housing, a front panel, a control locking device (30), a main locking device (40), an electrical controller (60) and a power supply device. The housing, the control locking device and the main locking device are almost the same as those of the first embodiment, and not more described here. The front panel further comprises a keypad mounted on the front panel. The coin passage device (15A) is different from the coin passage device (15) disclosed in the first embodiment. The coin passage device (15A) has two plates (151A), a first fastener, a second fastener and a conducting device (50), and the two plates (151 A) are mounted side by side. Each plate (151 A) has a top, a front, a rear edge, an ear (152A), an arc bottom edge (153A), a mounting hole (154A), an elongated hole (155A) and a recess. The plate (151A), the ear (152A), the mounting hole (154A) and the elongated hole (155A) are almost the same as the first embodiment, and no more described here. The recess is defined in the plate (151A) and communicates the arc bottom edge (153A). When the plate (51A) are mounted side by side, the recess in each plate (151A) aligned with each other. The conducting device (50) is mounted inside the recesses in the plates (151A) and extends out the arc bottom edge (153A). The conducting device (50) has a base (500), a resilient contact (51), a stationary contact (52) and an insulant pad (53). The base (500) is mounted inside the recesses in the plates (151A). The resilient contact (51) and the stationary contact (52) are separately mounted on the base. The insulant pad (53) is mounted on the resilient contact (51).

The electrical controller (60) is mounted on the inside surface of the partition (12), is connected electrically to the keypad on the front panel (20) and may be implemented with a circuit, a connecting device and a conducting device. The electrical controller (60) may be conventional and is understood by a person with ordinary skill in the relevant art, and further description would be redundant and has been omitted.

The power supply is provides electricity to the electrical controller (60) of the lock, is mounted on the housing (10), may be conventional and is understood by a person with ordinary skill in the relevant art, and further description would be redundant and has been omitted.

When the second embodiment of the lock for a locker is in use, a coin is input and presses the insulant pad (53) of the controller (50), the resilient contact (51) touches the stationary contact (52) and transfers a signal to the electrical controller (60). Then the electrical controller (60) may calculate the numbers of coins and determine whether a use can use the lock or not.

The advantage of the locking device for a storage cabinet in accordance with the present invention is as follows:

The lock for a locker in accordance with the present invention can be used for various coins without changing the coin passage device (15)(15A), therefore, the lock in accordance with the present invention provides a convenient way to operate the locking device.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lock for a locker, comprising
a housing having
a bracket having
a front having
two side edges,
an inner surface,
a coin slot defined in the front for a coin putting into and having a bottom edge, and
a lip formed on the inner surface of the front at the bottom edge of the coin slot, and
a first sidewall and a second sidewall, which are respectively formed with the side edges of the front,
a partition having
a surface,
a rear edge,
a slot defined in the rear edge of the partition, and
a pivotal seat formed on the surface,
coin passage device mounted between the first sidewall and the partition and having
at least one plate mounted between the first sidewall and the partition, and each one of the at least one plate having
a top,
a front,
a rear edge,
an ear formed on the rear edge of the coin plate and extending out of the slot in the partition,
an arc bottom edge forming a coin channel between the lip of the front for receiving coins and communicating with the coin slot in the bracket,
a mounting hole defined through the plate, and
an elongated hole defined through the plate near the top,
a first fastener mounted inside the mounting hole, and a second fastener mounted inside the elongated hole, and
a control slab pivotally mounted on the pivotal seat on the partition,
a front panel mounted on the front of the bracket and having
a coin slot defined in the front panel and facing the coin slot in the bracket and
two mounting holes defined in the front panel,
a control locking device mounted on the housing and the front panel, and
a main locking device mounted on the housing and the front panel.

2. The lock for a locker as claimed in claim 1, wherein the coin passage device has two plates.

3. The lock for a locker as claimed in claim 2, wherein the lock further comprises
an electrical controller mounted on the inside surface of the partition, and
a power supply device providing electricity to the electrical controller of the lock and mounted on the housing,
the coin passage device comprises
two plates respectively having a recess aligned to each other, and
a conducting device mounted inside the recesses in the plates and having
a base mounted inside the recesses in the plates,
a resilient contact mounted on the base and electrically connecting to the electrical controller and the power supply device,
a stationary contact mounted on the base and electrically connecting to the electrical controller and the power supply device, and
an insulant pad mounted on the resilient contact.

4. The lock for a locker as claimed in claim 1, wherein the control locking device has
a locking cylinder,
a lock holder mounted with the locking cylinder, and
a control key inserted into the locking cylinder for operating the locking cylinder.

5. The lock for a locker as claimed in claim 1, wherein the main locking device has
a locking cylinder mounted through the bracket and the front panel for pressing the control slab,
a tongue retractably mounted with the locking cylinder, and
a key inserted into the locking cylinder for operating the main locking device.
